(19) United States
(12) Patent Application Publication
(10) Pub. No.: US 2007/0078056 A1
(43) Pub. Date: Apr. 5, 2007

(54) Pelletized activated carbon, method for producing pelletized activated carbon, and canister

(75) Inventors: Susumu Abe, Bizen-shi (JP); Kuroo Kizaki, Bizen-shi (JP); Tetsuya Hanamoto, Bizen-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kuraray Chemical Co., Ltd., Bizen-shi (JP)

(21) Appl. No.: 11/521,505

(22) Filed: Sep. 15, 2006

(30) Foreign Application Priority Data
Sep. 16, 2005 (JP) JP2005-270630

(51) Int. Cl. C01B 31/08; B01D 53/02

(52) U.S. Cl. 502/416; 95/143

(57) ABSTRACT

A pelletized activated carbon and canister capable of reducing the amount of fuel gases evaporated and emitted into the atmosphere when a vehicle is stopped for a long time. A method for preparing the pelletized activated carbon including adding a binder and water to a powdery or granular activated carbon where the binder includes a cement (A) and at least one of a bentonite-based compound, a cellulose-based compound, and a polyvinyl alcohol-based compound; and the cement (A) is 30% by weight or more of the weight ratio of the solids; further including mixing with water to produce pellets of activated carbon. Pelletized activated carbon can be obtained by further hardening, drying, and cooling.

### BACKGROUND OF THE INVENTION

1. Field of the Invention

The present invention relates to pelletized activated carbon, a method for preparing the pelletized activated carbon, and a canister containing the pelletized activated carbon. The invention further relates to methods for producing the pelletized activated carbon and using the canister containing the pelletized activated carbon as a fuel gas emission prevention device.

2. Description of the Related Art

In recent years, worldwide concern over atmospheric environment improvement and global warming prevention has increased, and an evaporated fuel restraining device (i.e., a canister) has been used to reduce emissions of evaporated fuel gases into the atmosphere from a fuel tank of a gasoline internal combustion engine, which contribute to air pollution and global warming. Generally, this device is filled with an adsorbent, such as activated carbon, by which evaporated fuel is adsorbed and caught. During engine operation, the evaporated fuel adsorbed thereby is desorbed by bringing combustion air into the canister so as to be burned in the engine.

However, it is known that, if evaporated fuel gas is adsorbed and desorbed while using activated carbon without modification, a decrease in adsorption and desorption capacities will be caused, because an exothermic reaction occurs so that the temperature rises when adsorbed, and because an endothermic reaction occurs so that the temperature falls when desorbed. Therefore, to solve these problems, it is known that a heat storage material is used together with the activated carbon or that the specific heat of the activated carbon is heightened. For example, a proposal has been made to use a heat storage material inside a porous body, such as an activated carbon body (Japanese Published Unexamined Utility Model Application No. S63-57351), or to allow activated carbon to contain a liquid having a great specific heat so as to heighten the specific heat (Japanese Published Unexamined Patent Application No. S64-36961).

In recent years, in the United States, strict regulations have been applied to evaporated fuel gases, and the quantity of fuel gases evaporated and emitted from a vehicle being stopped for 72 hours (DBL) has been restricted. Therefore, there is a need to follow the regulations not only by adsorbing and desorbing a fuel gas evaporated and emitted from a vehicle, but also by lessening the evaporation and emission of the fuel gas into the atmosphere when the vehicle is stopped for a long time.

To meet the restriction, the present applicant has developed a fuel evaporation preventing device in which a second canister including honeycomb activated carbon is connected to the rear of a first canister, and has filed a patent application (Japanese Published Unexamined Patent Application No. H10-37812). This fuel evaporation preventing device is capable of usefully reducing the evaporation and emission of fuel gases into the atmosphere merely by connecting the second compact canister including honeycomb activated carbon to the rear of the first canister even if a vehicle is stopped for a long time. However, the method that uses honeycomb activated carbon is disadvantageous in the fact that the honeycomb structure is liable to be easily broken, in the fact that a sealing material, such as an O-ring, is required when honeycomb activated carbon is contained in the canister, and in the fact that high manufacturing costs must be paid. On the other hand, another type of canister is known. This canister is filled with a plurality of kinds of activated carbon that are different in adsorption and desorption capacities. This canister is formed such that a first adsorbent layer (principal chamber) is filled with activated carbon “A” that is high in the quantity of evaporated fuel to be adsorbed and that is low in retentivity, whereas each of a second adsorbent layer (subsidiary chamber) and adsorbent layers subsequent to the second one is filled with activated carbon that is moderate (i.e., intermediate) in the quantity of evaporated fuel to be adsorbed and that is low in retentivity (Japanese Published Unexamined Patent Application No. 2002-256989).

The functions of the canister are shown by “Butane Working Capacity” (BWC) that is a mean value between an increase by which a canister filled with activated carbon is allowed to adsorb a specific quantity of n-butane and a decrease by which the n-butane is desorbed therefrom by air. In general, when a carbon raw material is granulated according to a conventional method and is then carbonized and activated to produce activated carbon, the apparent density becomes smaller in proportion to a rise in the BWC, and, accordingly, the specific heat and the hardness also become smaller.

To prevent this, there is a method in which powdered active carbon is granulated or pelletized with a binder so as to be used as pelletized activated carbon. For example, woody granular activated carbon and shaped activated carbon made of bentonite white clay are known. Japanese Published Unexamined Patent Application No. S63-242343 discloses that these activated carbons are used in canisters. The present applicant has examined the shaped activated carbon closely and carefully. As a result, it has been proved that the adsorbability and adsorption rate of the activated carbon are markedly degraded by the binder, so that its performance is not necessarily satisfactory.

Additionally, Japanese Published Unexamined Patent Application No. S59-69146 discloses an adsorbent producing method in which powdered activated carbon, bentonite, and inorganic adhesive are mixed in the ratio 40 to 70:10 to 30:10 to 40, respectively, and then water of 80 to 120% by weight of the mixture is added to the mixture so as to produce a filter-shaped adsorbent. However, as is apparent from the embodiment, this document describes a planar adsorbent shaped with a mold, and hence pelletized activated carbon capable of standing actual use cannot be obtained even if the method disclosed is employed.

### SUMMARY OF THE INVENTION

It is therefore an object of the present invention to provide pelletized activated carbon for use in canisters that is capable of reducing the quantity of evaporated fuel gases emitted into the atmosphere even when a vehicle is stopped for a long time, and further to provide a method for preparing the pelletized activated carbon.

More particularly, The present invention relates to pelletized activated carbon suitable as a fuel gas emission preventing adsorbent that is excellent in adsorption and desorption capacities, that is superior in hardness, and through which only a slight amount of fuel gas is emitted into the atmosphere even if a vehicle has been stopped for a long time.

To achieve the object, the present inventors have paid attention to the fact that important matters includes the pore characteristics of activated carbon, the selection of a binder, and the mixture ratio of these elements, and have diligently researched thereon, thus having reached the present invention. In more detail, in one aspect, the present invention is pelletized activated carbon produced by mixing a binder and water with powdery or granular activated carbon.

In one embodiment, to obtain the pelletized activated carbon, cement (A) and at least one kind of compound (B) selected from the group consisting of a bentonite-based compound, a cellulose-based compound, and a polyvinyl alcohol-based compound are mixed together so as to serve as a binder and so that the cement (A) is 30% by weight or more in the weight ratio of solids. Water (C) is then mixed with the resulting mixture to produce pellets of activated carbon. The pellets are then hardened, dried, and cooled.

Additionally, the present invention is a method for preparing pelletized activated carbon, characterized in that the method comprises the steps of mixing cement (A) and at least one kind of compound (B) selected from the group consisting of a bentonite-based compound, a cellulose-based compound, and a polyvinyl alcohol-based compound with powdery or granular activated carbon so that the cement (A) accounts for 30% or more by weight in a solids weight ratio; adding water (C) to a resulting mixture so as to make pellets of activated carbon; hardening the pellets of activated carbon; and drying and cooling the pellets at a temperature of 300° C. or less.

Still additionally, the present invention is a canister for preventing fuel gas evaporation, characterized in that the canister is made up of a plurality of partitioned adsorbent layers and has an evaporated fuel gas intake port, an atmosphere port, and a purge port, wherein the partitioned adsorbent layers are arranged so that adsorbents disposed in the respective partitions gradually become smaller in adsorption capacity from a side on which the evaporated fuel gas intake port is positioned toward the atmosphere port, and wherein the pelletized activated carbon according to any aspect of the invention is disposed at least in a second layer among the partitioned adsorbent layers or in layers subsequent to the second layer.

Still additionally, the present invention is a canister for preventing fuel gas evaporation, characterized in that the canister is made up of a single or a plurality of partitioned adsorbent layers and has an evaporated fuel gas intake port, an atmosphere port, and a purge port, wherein a second canister is connected in series to the canister via a pipe, and the pelletized activated carbon is disposed in the second canister.

The pelletized activated carbon of the present invention is high in adsorptivity and in adsorption and desorption rate, and is excellent in mechanical strength, in water resistance, and in oil resistance. Therefore, the pelletized activated carbon can be suitably used in canisters. Since the pelletized activated carbon is excellent especially in the desorption of fuel vapors adsorbed, the amount of evaporated fuel gases emitted into the atmosphere can be reduced even when a vehicle is stopped for a long time. The pelletized activated carbon of the present invention can be suitably used in a canister having a plurality of partitioned adsorbent layers by disposing the pelletized activated carbon at least in a second layer or layers subsequent to the second one, or in a canister to which a second canister is attached by disposing the pelletized activated carbon in the second canister.

### BRIEF DESCRIPTION OF THE DRAWINGS

FIG. 1 is a schematic, cross-sectional view of a canister testing equipment.

FIG. 2 is a schematic, cross-sectional view of a second canister testing equipment.

FIG. 3 is a schematic, cross-sectional view of a “TEDLAR BAG.”

FIG. 4 is a schematic, perspective view showing an example of a canister.

### DETAILED DESCRIPTION OF THE INVENTION

Specific limitations are not imposed on a carbonaceous material used as the raw material of activated carbon used in the present invention if the activated carbon is produced by activation. Therefore, the material can be broadly selected from a plant-based material, a mineral-based material, a natural material, a synthetic material, etc. In more detail, wood, charcoal, and fruit shells, such as coconut shells, can be used as the plant-based carbonaceous material. Coal, petroleum and/or coal pitch, and coke can be used as the mineral-based carbonaceous material. Natural fibers, such as cotton or hemp, regenerated fibers, such as rayon or viscose rayon, and semi-synthetic fibers, such as acetate or triacetate, can be used as the natural material. Polyamide resin, such as nylon, polyvinyl alcohol resin, such as vinylon, polyacrylonitrile resin, such as acrylic, polyolefin resin, such as polyethylene or polypropylene, polyurethane, phenol resin, and polyvinyl chloride resin can be used as the synthetic material. These materials may be blended together for use.

Specific limitations are not imposed on the shape of the carbonaceous material, and hence materials various in shape, such as granular, powdery, fibrous, or sheet-like materials, can be used. Preferably, from the viewpoint of being pelletized, the material is powdery or granular, and the particle size is 0.3 mm or less. Although the carbonaceous material is turned into activated carbon by carbonization and activation, a known conventional carbonization condition and a known conventional activation condition can be employed to carbonize and activate the material.

Preferably, the center pore radius of powdery or granular activated carbon is 3.5 to 6.0 nm, because a too small pore radius brings about a too great adsorbing force, which makes the desorption difficult, whereas a too large pore radius lessens the amount of adsorption although excellent desorptivity can be obtained.

In the present invention, powdery or granular activated carbon is pelletized by mixing with or adding a binder. One feature of the present invention resides in the fact that the binder is selected and used in a specific ratio. In one embodiment, the pelletized activated carbon of the present invention is obtained in the following manner. Cement (A) and at least one kind of compound (B) selected from the group consisting of a bentonite-based compound, a cellulose-based compound, and a polyvinyl alcohol-based compound (hereinafter, referred to simply as “compound (B)”) are mixed with powdery or granular activated carbon so that the cement (A) is 30% or more by weight in the solids weight ratio. Preferably the binder is added to the activated carbon. Water (C) is then added to the resulting mixture.

Hydraulic cement, such as Portland cement, blast furnace cement, silica cement, slag cement, or alumina cement, that is chiefly composed of silicate calcium can be mentioned as the cement (A). Ordinary Portland cement, high early-strength cement, and low heat Portland cement are examples of the Portland cement. Among these, the early-strength cement is preferable.

At least one kind of compound selected from the group consisting of a bentonite-based compound, a cellulose-based compound, and a polyvinyl alcohol-based compound is used as the compound (B). Sodium bentonite and calcium bentonite can be mentioned as the bentonite-based compound.

A cellulose derivative obtained by substituting alkyl ether or carboxymethyl for cellulose and hydroxyl can be mentioned as the cellulose-based compound. Among these, methyl cellulose or carboxymethyl cellulose is preferable. Polyvinyl alcohol or variously modified polyvinyl alcohol can be mentioned as the polyvinyl alcohol-based compound.

As mentioned above, in one embodiment, it is important to mix the cement (A) used as a binder and at least one kind of compound (B) selected from the group consisting of a bentonite-based compound, a cellulose-based compound, and a polyvinyl alcohol-based compound with powdery or granular activated carbon so that the cement (A) is 30% or more by weight in the solids weight ratio. Preferably, the cement (A) is mixed to be 50 to 75% by weight, and, more preferably, 60 to 75% by weight.

It is preferable to have the mixture ratio of the binder so that the cement (A) is added and mixed with 100 parts by weight of activated carbon so as to be 80 to 300 parts by weight, preferably 120 to 280 parts by weight, and the compound (B) is added and mixed therewith so as to be 2 to 30 parts by weight. Preferably, the water (C) is added so as to be 160 to 280 parts by weight with respect to 100 parts by weight of the mixture consisting essentially of the activated carbon, the cement (A), and the compound (B).

A mixture consisting essentially of the powdery or granular activated carbon, the cement (A), the compound (B), and the water (C) is kneaded by a kneader or the like. The kneaded mixture is then shaped into pellets by a pelletizing machine such as a pelleter. The pellets are left at rest preferably for two days, more preferably for about ten days, at normal temperature (i.e., at room temperature), and are hardened. Thereafter, the hardened pellets are dried at a temperature of 300° C. or less, and are then cooled at normal temperature, thus producing the pelletized activated carbon of the present invention.

It is preferable to use a blend of two or more kinds of activated carbons that are different at least in pore distribution and/or adsorption properties as the powdery or granular activated carbon, because pelletized activated carbon that has an arbitrary pore size distribution can be easily produced, and the adsorptivity thereof can be arbitrarily controlled.

The pelletized activated carbon of the present invention can be produced without causing a decrease in the adsorption and desorption capacities of activated carbon, and can show excellent DBL performance unlike a method in which one of or a mixture of bentonite, water glass, carboxymethyl cellulose, etc., is mixed with activated carbon. Pelletized activated carbon for use in canisters that can stand actual use cannot be obtained even if only cement is mixed with activated carbon. The reason for this cannot be clearly explained. Presumably, in the pelletized activated carbon of the present invention, the cement used as a binder improves an effect by which the specific gravity of activated carbon is heightened without closing the pore of the activated carbon, and the pelletized activated carbon in which the adsorption and desorption capacities of the activated carbon are not degraded can be produced by compensating inferior characteristics in a binder function with the compound (B).

Preferably, the n-butane desorption percentage is 78% or more, more preferably 80% or more, because the pelletized activated carbon of the present invention is used in canisters. Additionally, preferably, the hardness of the pelletized activated carbon is 80% or more. Preferably, from the viewpoint of decreasing the DBL, in a canister in which an adsorbent layer is partitioned into a plurality of layer parts, the pelletized activated carbon of the present invention is disposed at least in a second layer or in layers subsequent to the second one. Alternatively, in a canister to which a second canister is attached, the pelletized activated carbon is disposed in the second canister. Preferably, in the canister in which an adsorbent layer is partitioned into a plurality of layer parts, the adsorbents are arranged so that the adsorbent layer parts gradually become smaller in adsorption capacity from the side on which an evaporated fuel gas intake port is positioned toward an atmosphere port.

The center pore radius of activated carbon used to produce the pelletized activated carbon of the present invention, the n-butane adsorption and desorption percentage of the pelletized activated carbon, and the hardness and DBL of the pelletized activated carbon were measured in the following way. With regard to the center pore radius of activated carbon

The center pore radius was calculated from a pore distribution curve according to a water vapor adsorption method. The pore of the activated carbon has a pore radius less than a pore radius (r) calculated based on the Kelvin equation shown as Equation (I) below, from one atmospheric pressure (absolute pressure) peculiar to the sulfuric acid concentration of a sulfuric acid aqueous solution and the value (P) of saturated water vapor pressure at 30° C. In other words, the cumulative pore volume of pores each of which is less than a pore radius calculated based on the Kelvin equation is the volume of 30° C. water corresponding to the saturated adsorption amount in a measurement test therefor.
r=−[2 Vmγ cos Φ]/[RTln(P/P₀)] (I)

r: pore radius (cm)

Vm: molecular volume of water (cm³/mol)=18.079 (30° C.)

Φ: contact angle between of capillary wall and water (°)=55°

R: gas constant (erg/deg·mol)=8.3143×10⁷

T: absolute temperature (K)=303.15

P: saturated vapor pressure shown by water in pores (mmHg)

P₀: one atmospheric pressure of water (absolute pressure); saturated vapor pressure (mmHg)=31.824 at 30° C.

Measurement tests concerning the saturated adsorption amount were applied to thirteen kinds of sulfuric acid aqueous solutions different in sulfuric acid concentration (i.e., eleven kinds of sulfuric acid aqueous solutions having specific gravities of 1.05 to 1.30 at 0.025 intervals, a sulfuric acid aqueous solution having a specific gravity of 1.35, and a sulfuric acid aqueous solution having a specific gravity of 1.40). In each measurement test, the cumulative pore volume of pores less than a corresponding pore radius was calculated. A pore distribution curve of the activated carbon can be obtained by plotting the thus obtained cumulative pore volume with respect to the pore radius. The radius indicating the highest peak value in this pore distribution curve is set as a center pore radius.

With regard to the n-butane desorption percentage (%) and the n-butane effective adsorption amount (BWC) of the pelletized activated carbon

1) The packing density of the pelletized activated carbon is measured according to JIS K1474.

2) Based on the packing density measured by step 1), a glass column having an inner diameter of 17.5 mm is packed with a 24 mL sample, is then weighed (Ag), and is set in a constant-temperature bath having a temperature of 25° C.

3) N-butane (99.9% or more purity) is admitted into the glass column for 20 minutes or more at a flow rate of 300 mL/minute in an upflow manner. Thereafter, the glass column is removed, and weighing is performed (Cg).

4) The glass column is reset in the apparatus, and dry air is admitted into the glass column at a flow rate of 240 mL/minute for 20 minutes in a downflow manner. Thereafter, the glass column is removed, and weighing is performed (Dg).

5) These operations are performed, and, according to the following equations, the n-butane desorption percentage and the butane effective adsorption amount (BWC) regarded as the desorption amount per 1 dL pelletized activated carbon are calculated.
N-butane desorption percentage=(Cg−Dg)/(Cg−Ag)×100(%)
BWC(g/dL)=(Cg−Dg)/0.24
With respect to the hardness of the pelletized activated carbon

According to JIS K1474, a hardness testing saucer into which a granular sample has been put together with steel balls is shaken, and sieving is performed. The mass of the sample remaining on a sieve is measured, and the hardness is calculated from the ratio between this mass and the original mass. The outlines are as follows.

1) The sample is sieved for 10 minutes by use of two sieves having mesh openings respectively corresponding to the upper limit and the lower limit within the nominal particle size range.

2) A 200 mL graduated cylinder is packed with the sieved sample up to the marked line 100 mL of the cylinder while tapping the cylinder. This sample is measured down to the order of 0.1 g.

3) The sample is put into the hardness testing saucer together with fifteen polished steel balls each of which has a diameter of 12.7 mm and fifteen polished steel balls each of which has a diameter of 9.5 mm.

4) The saucer is attached to a sieving and shaking machine, and is shaken for 30 minutes.

5) All the sample excluding the steel balls is put into a sieve, which has mesh openings lower by two grades than the mesh opening corresponding to the lower limit within the nominal particle size range, and a saucer. The sieve and the saucer are then attached to the sieving and shaking machine.

6) After being shaken for 3 minutes, the mass of the sample remaining on the sieve and on the saucer is measured down to the order of 0.1 g.

7) The hardness (H) is calculated according to the following equation.
H=(W/S)×100(%)
where W is the mass (g) of the sample remaining on the sieve, and S is the mass total (g) of the sample remaining on the sieve and on the saucer.
With Regard to DBL
Pretreatment

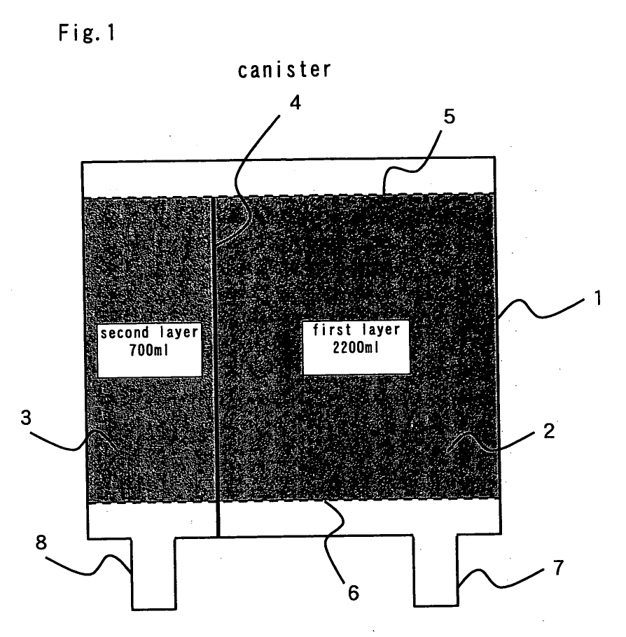

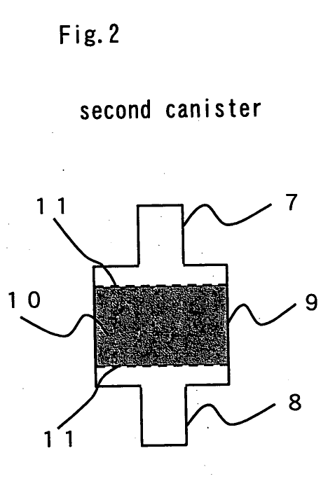

1) As shown in FIG. 1, a canister testing equipment 1 having an effective volume of 2900 mL (the first layer 2200 mL+the second layer 700 mL) and a height/equivalent diameter (the first layer 2.7, the second layer 3) is filled with activated carbon “Kuraraycoal 3GX” (manufactured by Kuraray Chemical Co., Ltd.) serving as activated carbon 2 for the first layer and the pelletized activated carbon of the present invention serving as activated carbon 3 for the second layer, and is closed with a lid. If a second canister testing equipment 9 having an effective volume of 100 mL and a height/equivalent diameter of 0.58 as shown in FIG. 2 is connected thereto in series, the canister testing equipment 1 is filled with activated carbon “Kuraraycoal3GX” (manufactured by Kuraray Chemical Co., Ltd.) serving as activated carbon for the first layer and activated carbon “2GK-C72 (manufactured by Kuraray Chemical Co., Ltd.) serving as activated carbon for the second layer, and the second canister testing equipment 9 is filled with the palletized activated carbon of the present invention. The “equivalent diameter” mentioned above is a diameter calculated in terms of a circle when the cross-sectional shape is not circular. In the adsorption capacity, the relation 3GX>2GK-C7 exists. In FIG. 1, reference numeral 4 designates a partition, and reference numerals 5 and 6 designate dispersing plates. In FIG. 2, reference numeral 10 designates pelletized activated carbon, and reference numeral 11 designates a dispersing plate.

2) Simulated gasoline vapors (in the volume ratio, butane:pentane:hexane=25:50:25) with a flow rate of 1.5 g/minute and air with a flow rate of 500 mL/minute are admitted into an evaporated fuel gas inlet 7 of the canister testing equipment at an atmosphere temperature of 25° C., and the concentration of gas emitted from an evaporated fuel gas outlet 8 of the canister 20 testing equipment is measured with a hydrocarbon analyzer. After the outlet concentration of the canister testing equipment reaches 10000 ppm (breakthrough point), the ventilation is stopped. Air having a volume 400 times that of the canister testing equipment is then introduced from the outlet 8 in opposition to a direction followed when adsorbed, so as to perform purging.

3) The operation of step 2) is performed by 10 cycles, and the activated carbons are left at rest for one night (i.e., 16 to 20 hours) at 25° C.

4) 50 volt n-butane diluted with air is admitted into the canister at a flow rate of 40 g/hour at an atmosphere temperature of 25° C., and the canister outlet concentration is measured with a hydrocarbon analyzer. After the outlet concentration of the canister testing equipment reaches 10000 ppm (breakthrough point), the ventilation is stopped. Air having a volume 150 times that of the canister testing equipment is then introduced from the outlet 8 in the opposite direction so as to perform purging.

Measurement of DBL

1) The atmosphere temperature is set at 30° C., and the activated carbons are left at rest for one night (i.e., for 16 to 20 hours). Thereafter, a simplified DBL test is performed.

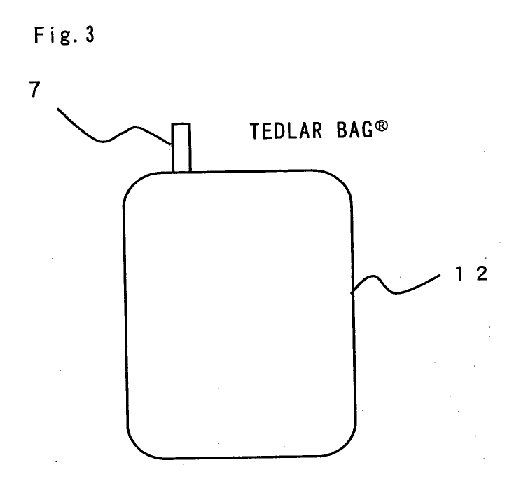

2) A simulated gasoline vapor supply source is connected to the canister testing equipment. An outlet of the canister testing equipment and a leak measuring TEDLAR BAG® 12 shown in FIG. 3 are connected together via a pipe or a hose. The “TEDLAR BAG” is a gas collecting bag that does not cause gas adsorption and gas infiltration, and is a trade name manufactured by DuPont.

3) Simulated gasoline vapors with a flow rate of 0.19 g/minute and air with a flow rate of 63 mL/minute are admitted into the canister testing equipment, and an amount leaked therefrom is measured on the condition of at 35° C. for 1.5 hours, at 35° C. for 0.5 hours+ at 40° C. for 1 hour and at 40° C. for 1 hour, respectively (first day).

4) The atmosphere temperature is set at 30° C., and the activated carbons are left at rest for 2 hours. Thereafter, purging is performed with air with a flow rate of 100 mL/minute for 2 hours. Thereafter, the activated carbons are left at rest for 17 hours.

5) Simulated gasoline vapors with a flow rate of 0.143 g/minute and air with a flow rate of 47.3 mL/minute are admitted into the canister testing equipment, and an amount leaked therefrom is measured on the condition of at 35° C. for 2 hours and at 40° C. for 2 hours, respectively (second day).

6) The gas concentration is measured by a gas chromatograph, and the gas volume is measured by a gas meter. The amount leaked therefrom is calculated from the product of the gas concentration and the gas volume (i.e., concentration X volume) inside the TEDLAR BAG®. Although the present invention will be described with reference to the following examples, the present invention is not limited to these examples. In the examples, the mixture ratios are all based on parts by weight.

### EXAMPLES 1 TO 13, COMPARATIVE EXAMPLES 1 TO 4

“Kuraraycoal 3GX” (manufactured by Kuraray Chemical Co., Ltd.) was put into a rotary kiln, and was activated with water vapors at temperatures of 920 to 950° C. Four kinds of activated carbons having center pore radiuses of 3.3, 4.2, 4.8, and 5.0 nm, respectively, were obtained by changing the period of activation time. Thereamong, the activated carbon having a center pore radius of 4.8 nm was characterized in that the n-butane adsorption amount according to the BWC method was 50%, the desorption percentage was 77%, and the BWC was 11.9 g/dL.

Powdered activated carbon 100 parts by weight obtained by crushing these activated carbons into particles each of which has a particle size of 0.1 mm or less by use of a crusher were mixed with ordinary Portland cement (manufactured by Sumitomo Osaka Cement Co., Ltd.), high early-strength cement (manufactured by Sumitomo Osaka Cement Co., Ltd.), or alumina cement (manufactured by Korean Union Co., Ltd.) serving as the cement (A), and were further mixed with bentonite (trade name “Ben-Gel”, manufactured by HOJUN Co., Ltd.) and/or carboxymethyl cellulose (hereinafter, abbreviated as “CMC”) serving as the compound (B). Water is then added to the resulting mixture while sufficiently kneading these. Thereafter, the mixture was extruded to produce pellets by use of a hydraulic pelletizer. The size of pelletized activated carbon can be arbitrarily adjusted by changing the size of a die hole, and, in this example, the diameter thereof was set at 2.0 mm.

In Comparative Examples 1 and 2, bentonite and water glass were used instead of the cement. In Comparative Example 3, no compound (B) was used. In Comparative Example 4, pellets were produced in the mixture ratio mentioned in the embodiment of Patent Document 5. In the examples and the comparative examples, the JIS hardness and the BWC performance were measured. The results are shown in Table 1. In Examples 1 to 13 and Comparative Examples 2 and 3, a shaped article was cut to have a suitable length, and was dried for 6 hours in a drying apparatus at temperatures of 120 to 150° C. In Comparative Example 1, a shaped article was cut to have a suitable length, and was burned up to 650° C. in an electric furnace in an inert gas atmosphere.

A canister having an effective volume of 2900 mL (first layer 2200 mL+second layer 700 mL) and a height/equivalent diameter (first layer 2.7, second layer 3) is filled with activated carbon “Kuraraycoal 3GX” (manufactured by Kuraray Chemical Co., Ltd.) serving as activated carbon for the first layer and the pelletized activated carbon of the present invention serving as activated carbon for the second layer. The DBL performance was measured. The results are shown in Table 1.

A canister having an effective volume of 2900 mL (first layer 2200 mL+second layer 700 mL) and a height/equivalent diameter (first layer 2.7, second layer 3) is filled with activated carbon “Kuraraycoal 3GX” (manufactured by Kuraray Chemical Co., Ltd.) serving as activated carbon for the first layer and activated carbon “2GK-C7” (manufactured by Kuraray Chemical Co., Ltd.) serving as activated carbon for the second layer, whereas a second canister having an effective volume of 100 mL and a height/equivalent diameter of 0.58 is filled with the pelletized activated carbon of the present invention. The canisters were connected together via a pipe, and the DBL performance was measured. The results are shown in Table 1.

TABLE 1

| | | Pore | | | | | | | | | | | | |
|---|---|---|---|---|---|---|---|---|---|---|---|---|---|---|
| | | radius of | Mixture ratio (parts by weight) | | | | | | Weight | Drying or | | | | |
| | | activated | Acti- | | | Water | | | ratio of | calcining | Desorption | | Hard- | |
| | | carbon | vated | | Ben- | glass | CMC | | cement in | temperature | percentage | BWC | ness | DBL |
| | | mm | carbon | Cement | tonite | solids | solids | Water | solids (%) | (° C.) | % | g/dl | % | mg |
| Example | 1 | 4.8 | 100 | Ordinary 200 | 5 | | 3 | 235 | 64.9 | 120 | 83.7 | 6.5 | 93 | 11.6 |
| | 2 | 4.2 | 100 | Ordinary 150 | 10 | | | 185 | 57.7 | 150 | 80.9 | 7.4 | 88 | 16.8 |
| | 3 | 4.8 | 100 | High early- | 15 | | | 185 | 56.6 | 120 | 81.4 | 7.2 | 97 | 12.8 |
| | | | | strength 150 | | | | | | | | | | |
| | 4 | 5 | 100 | High early- | 28 | | | 185 | 48.4 | 120 | 80.5 | 7.4 | 93 | 18.2 |
| | | | | strength 120 | | | | | | | | | | |
| | 5 | 3.3 | 100 | Ordinary 200 | | | 3 | 240 | 66.0 | 120 | 80.7 | 6.3 | 84 | 22.3 |
| | 6 | 4.8 | 100 | High early- | | | 15 | 185 | 56.6 | 120 | 80 | 6.8 | 75 | 33.2 |
| | | | | strength 150 | | | | | | | | | | |
| | 7 | 3.3 | 100 | High early- | 5 | | | 280 | 72.7 | 120 | 87.5 | 5.7 | 95 | 10.6 |
| | | | | strength 1 | | | | | | | | | | |
| | | | | High early- | | | | | | | | | | |
| | | | | strength 280 | | | | | | | | | | |
| | 8 | 5 | 100 | High early- | 28 | | | 170 | 41.3 | 150 | 80 | 7.6 | 85 | 43.7 |
| | | | | strength 90 | | | | | | | | | | |
| | 9 | 4.8 | 100 | Alumina 150 | 15 | | | 185 | 56.6 | 120 | 81.6 | 6.9 | 67 | 14.8 |
| | 10 | 4.8 | 100 | Ordinary 110 | 34 | | | 180 | 45.1 | 150 | 81 | 7.5 | 87 | 42.3 |
| | 11 | 4.8 | 100 | Ordinary 75 | 38 | | | 160 | 35.2 | 150 | 80 | 7.4 | 85 | 44.1 |
| | 12 | 20 + 4.8 | 100 | High early- | 15 | | | 185 | 56.6 | 120 | 79 | 7.2 | 96 | 12.6 |
| | | | | strength 150 | | | | | | | | | | |
| | 13 | 4.8 | 100 | High early- | 15 | | | 185 | 56.6 | 120 | 81.4 | 7.2 | 97 | 10.4 |
| | | | | strength 150 | | | | | | | | | | |
| Comparative | 1 | 4.8 | 100 | | 150 | | | 160 | — | 650 | 73.4 | 8.8 | 68 | 66.0 |
| example | 2 | 3.3 | 100 | | | 33 | | 200 | — | 120 | 74.8 | 6.8 | 32 | 118.6 |
| | 3 | 4.8 | 100 | Ordinary 150 | | | | 250 | 60 | 120 | 80.2 | 6.6 | 20 | 20.4 |
| | 4 | 4.8 | 100 | Ordinary 40 | 50 | | | 120 | 21.1 | 120 | 78 | 10.5 | 18 | 38 |

The pelletized activated carbon used in the second layer and layers subsequent to the second one of the canister is expected to be high in BWC and in hardness and be low in DBL. The quality of the pelletized activated carbon is determined by comprehensively judging these factors. The adsorptivity of the pelletized activated carbon of the present invention maintains about 90% in relation to the amount of adsorption calculated from a binder mixture ratio based on the amount of n-butane adsorption of raw activated carbon. Likewise, the desorptivity thereof maintains a level equal to or greater than that of the raw activated carbon. Therefore, an adverse influence on the adsorption and desorption properties caused by the binder is negligible.

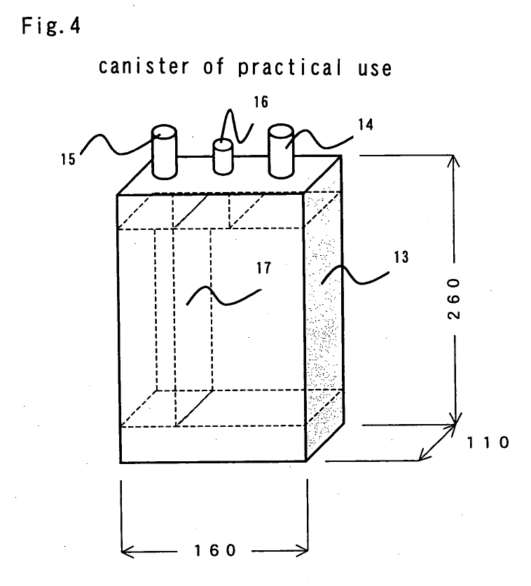

A canister to be mounted in a vehicle is substantially the same as the canister testing equipment mentioned above. FIG. 4 is a perspective, schematic view of a rectangular type (160 mm×110 mm×260 mm). In FIG. 4, reference numeral 13 designates a canister of practical use, reference numeral 14 designates an evaporated fuel gas intake port, reference numeral 15 designates an atmosphere port, reference numeral 16 designates a purge port, and reference numeral 17 designates a partition between the first layer and the second layer. Although FIG. 4 shows an example of one canister, there is a case in which the present invention is embodied in the form of a canister connected to a second canister through a hose or the like (not shown).

The present invention can provide pelletized activated carbon useful for environmental preservation and a method for preparing the pelletized activated carbon. The palletized activated carbon of the present invention is high in adsorptivity and in adsorption and desorption rate, and is excellent in mechanical strength, in water resistance, and in oil resistance. Therefore, the pelletized activated carbon is suitably used in a canister of, for example, a vehicle that receives vibrations and mechanical shocks. Even if the vehicle is stopped for a long time, the amount of fuel gases evaporated and emitted therefrom into the atmospheric can be reduced. Therefore, the pelletized activated carbon is preferably used as an adsorbent especially for a second layer and layers subsequent to the second one of the canister. Additionally, the pelletized activated carbon of the present invention can be used not only for canisters but also for various uses, such as deodorizing, solvent recovering, or catalyzing, and is industrially useful.

Japanese application 2005-270630 is incorporated herein by reference in its entirety.

1. A pelletized activated carbon produced by:
mixing a binder, water and a powdery or granular activated carbon to form a binder-containing mixture,
thereafter adding water (C) to the binder-containing mixture to form pellets of the activated carbon, and
then hardening, drying, and cooling the pellets to form the pelletized activated carbon,
wherein the binder comprises a mixture of a cement (A) and at least one compound (B) selected from the group consisting of a bentonite-containing compound, a cellulose-containing compound, and a polyvinyl alcohol-containing compound, and
wherein the binder comprises 30% or more by weight of the cement (A) based on the total weight of the solids in the binder.

2. The pelletized activated carbon of claim 1, wherein the powdery or granular activated carbon has a center pore radius of from 3.5 to 6.0 nm.

3. The pelletized activated carbon of claim 1, wherein the powdery or granular activated carbon is a blend of two or more different kinds of activated carbon having at least one of a different pore distribution and a different adsorption capacity.

4. The pelletized activated carbon of claim 1, wherein an n-butane desorption percentage of the pelletized activated carbon is 78% or more.

5. The pelletized activated carbon of claim 1, wherein the hardness of the pelletized activated carbon is 80% or more.

6. The pelletized activated carbon of claim 1, wherein the binder comprises the cement (A) and a bentonite-containing compound.

7. The pelletized activated carbon of claim 1, wherein the binder comprises the cement (A) and a cellulose-containing compound.

8. The pelletized activated carbon of claim 1, wherein the binder comprises the cement (A) and a polyvinyl alcohol-containing compound.

9. The pelletized activated carbon of claim 1, wherein the cement (A) is present in an amount of from 50 to 75% by weight.

10. The pelletized activated carbon of claim 1, wherein the pellets comprise the cement (A) in an amount of from 80 to 300 parts by weight, the compound (B) in an amount of from 2 to 30 parts by weight, and the water (C) in an amount of from 160 to 280 parts by weight based upon the total weight of the cement (A) and the compound (B).

11. A method for preparing a pelletized activated carbon, comprising:
mixing a cement (A) and at least one compound (B) selected from the group consisting of a bentonite-containing compound, a cellulose-containing compound, and a polyvinyl alcohol-containing compound, with a powdery or granular activated carbon to form a first mixture wherein the cement (A) is present in an amount of at least 30% by weight based on the total weight of the solids;
mixing water (C) with the first mixture to form pellets of the activated carbon;
hardening the pellets of the activated carbon; and
drying and cooling the pellets at a temperature of 300° C. or less to form the pelletized activated carbon.

12. The method of claim 11, wherein the first mixture comprises the cement (A) and the compound (B) in amounts of 80 to 300 parts by weight and 2 to 30 parts by weight, respectively, based on 100 parts by weight of the activated carbon, and wherein 160 to 280 parts-by-weight of water (C) is added to 100 parts by weight of the first mixture based on the weight of the activated carbon, the cement (A), and the compound (B).

13. The method of claim 11, wherein the powdery or granular activated carbon comprises two or more kinds of activated carbon that are different from each other in at least one of pore distribution and adsorption capacity.

14. A canister for preventing fuel gas evaporation, comprising:
a plurality of partitioned adsorbent layers, an evaporated fuel gas intake port, an atmosphere port, and a purge port,
wherein the partitioned adsorbent layers are arranged so that adsorbents disposed in respective layers gradually become smaller in adsorption capacity from a side on which the evaporated fuel gas intake port is positioned toward the atmosphere port, and wherein the pelletized activated carbon of claim 1 is disposed at least in a second layer among the partitioned adsorbent layers or in layers subsequent to the second layer.

15. An evaporate canister for preventing fuel gas evaporation, comprising:
a single or a plurality of partitioned adsorbent layers, an evaporated fuel gas intake port, an atmosphere port, and a purge port,
wherein a second canister is connected in series to the evaporate canister via a pipe, and the pelletized activated carbon of claim 1 is disposed in the second canister.

16. The canister for preventing fuel gas evaporation of claim 15, wherein the partitioned adsorbent layers are arranged so that adsorbents disposed in respective partitions gradually become smaller in adsorption capacity from a side on which the evaporated fuel gas intake port is positioned toward the atmosphere port.
